(19) United States
(12) Patent Application Publication
(10) Pub. No.: US 2006/0070013 A1
(43) Pub. Date: Mar. 30, 2006

(54) Method and system to drill down graphically

(76) Inventor: Peter Vignet, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/954,594

(22) Filed: Sep. 29, 2004

(51) Int. Cl. G06F 17/00; G06F 9/00

(52) U.S. Cl. 715/854

(57) ABSTRACT

A method and system drill down graphically are disclosed. When a chart or a graph represents a plurality of data components, a user may wish to know more details about a particular component of the data presented in the graph. A method and system drill down graphically enables a user to view the details related to a particular portion of a graph by simply selecting a particular portion of the graph. The system to drill down graphically include a chart models generator to generate an initial chart model and a first level details chart model, wherein the initial chart model includes a first expandable item including a link to a first level details chart associated with the first level details chart model; a dynamic page component to generate an initial chart corresponding to the initial chart model and the first level details chart corresponding to the details chart model, wherein the initial chart includes a graphical representation of the first expandable item; and a display component to provide the details chart to a user, responsive to a selection of the graphical representation of the first expandable item by the user.

### FIELD OF THE INVENTION

An embodiment relates generally to enterprise resource and program management, and more particularly to a method and system to drill down graphically.

### BACKGROUND OF THE INVENTION

Software applications in the field of enterprise resource and program management attempt to integrate all facets of a business including planning, manufacturing, sales, and marketing. As the resource and program management methodology has become more popular, software applications have emerged to help users implement resource and program management in business activities to provide visibility into the entire portfolio of enterprise programs and projects, while supporting strategic capacity planning and resource allocation based on up-to-date information on skills and availability of the resources.

A resource and program management system may enable users to manage and execute complex information technology (IT) and research and development (R&D) projects. Such system may, for example, integrate information from existing project management, human resources, financial, and time-tracking systems in order to provide a complete overview of a project portfolio. Business data may be presented to a user in a tabular form as well as in a form of graphs and charts. A good user experience may result from easy rendering of business graphics in a portal page.

### SUMMARY

In one embodiment, a method and system to drill down graphically include a chart models generator to generate an initial chart model and a first level details chart model, wherein the initial chart model includes a first expandable item including a link to a first level details chart associated with the first level details chart model; a dynamic page component to generate an initial chart corresponding to the initial chart model and the first level details chart corresponding to the details chart model, wherein the initial chart includes a graphical representation of the first expandable item; and a display component to provide the details chart to a user, responsive to a selection of the graphical representation of the first expandable item by the user.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIGS. 1A-1C show exemplary graphs generated utilizing the system and the method to drill down graphically, according to one embodiment of the present invention;

FIG. 2 is a network diagram illustrating a system having a client-server architecture, according to one embodiment of the present invention;

FIG. 3 is a block diagram illustrating a system to drill down graphically, according to one embodiment of the present invention;

FIG. 4 is a flowchart illustrating a method to drill down graphically, according to an embodiment of the present invention;

FIG. 5 is a diagrammatic representation of a computer system, within which a set of instructions, for causing the machine to perform any one or more of the methodologies discussed herein, may be executed.

### DETAILED DESCRIPTION

A method and system to drill down graphically are described. In the following description, for purposes of explanation, numerous specific details are set forth in order to provide a thorough understanding of the present invention. It will be evident, however, to one skilled in the art that the present invention may be practiced without these specific details.

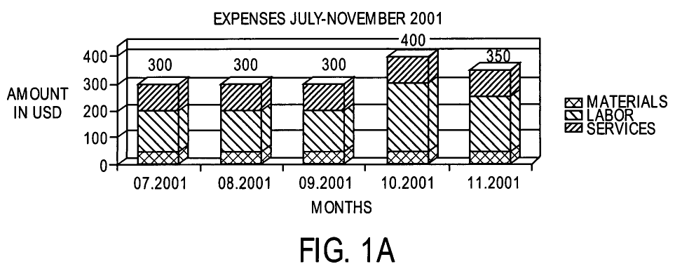

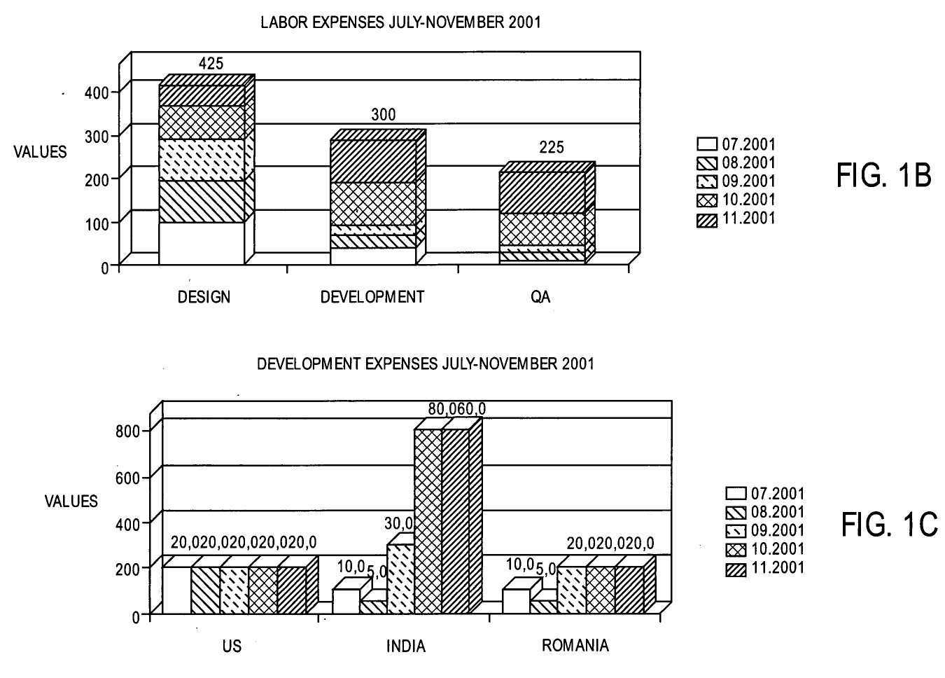

Business graphics (e.g., bar graphs and stacked graphs) may provide a useful means to compare, contrast and evaluate business data. Thus, bar graphs may be used to highlight separate quantities, providing for ready comparison of quantities within or among categories. Stacked bar graphs, on the other hand, may be useful in displaying the quantities as well as the relative proportions of the categories to each other as well as to the whole. For example, in FIG. 1A, a vertical stacked graph represents monthly operational costs, where the value for each month is stacked as a sum of materials costs, service costs, and labor costs.

When a chart or a graph represents a plurality of data components (e.g., costs for each type of costs per month), a user may wish to know more details about a particular component of the summarized data presented in the graph. For instance, in FIG. 1A, the labor costs for the month of October are significantly higher than the labor costs for the previous months. It is reasonable to suppose that a user may wish to study the details associated with the labor costs in October. In one embodiment, a user may be enabled to view the details related to a particular portion of a graph by simply selecting a particular portion of the graph.

Referring to FIG. 1A and according to one exemplary embodiment, a user may select a portion of the graph representing labor costs for the month of October (e.g., by clicking on the portion of the graph) and be presented with another graph illustrating labor costs for the period from July 2001 to November 2001, (e.g., the graph of FIG. 1B). As shown in FIG. 1B, the labor costs in this example comprise design, development, and quality assurance (QA) costs. The graph of FIG. 1B makes it evident that, while costs associated with design remained approximately the same for the first three months and then decreased in the course of October and November, costs associated with development increased in October and November. The user may then wish to further study data related to development costs. By selecting clicking on the development stack in FIG. 1B (e.g., clicking on the development stack), the user may be presented with yet another graph, as shown in FIG. 1C, illustrating development costs for the period from July 2001 to November 2001. A quick glance at the graph of FIG. 1C reveals that the increase in development costs in October and November is primarily due to increase in costs for development done in India. The above process, which may be referred to as drilling down graphically, may be repeated until the user reaches a graph with the desired level of detail.

This user friendly and efficient way to drill down graphically may be implemented, in one exemplary embodiment, utilizing links (e.g., in an exemplary form of a uniform resource locator, URL) attached to one or more portions of a chart to be rendered to a user.

In a web-based environment, client web browsers may render graphs provided by servlets on a web server. Graphs may be built utilizing chart models. Chart models, in turn, may be built from table data, which may be provided by back end calls from a web server (e.g., to a database server). In the example illustrated in FIG. 1A, the table corresponding to the chart model for the stacked graph of FIG. 1A includes a data series column (here, the types of costs), a categories column (here, months), and a values column. The values column includes an amount in USD for each type of expense in the first column per each month in the second column. A corresponding chart model may include one or more items, where each item is characterized by the value for a particular data series element for a particular category (here, the value for a given month for a type of expense). In one exemplary embodiment, a chart model may also include a field, which can be used to contain link information referring to another chart or a group of charts on the same page. For example, a chart model item corresponding to labor costs in October in FIG. 1 may include a link to a chart (e.g., the stacked graph of FIG. 1B) representing details of labor costs for the relevant period. A chart model corresponding to the chart in FIG. 1A, in one embodiment, may be generated such that some or all items in the chart model have associated links to other relevant charts. A chart model may also include a field containing a tool tip to provide a description of the item to a user as the user positions a cursor over the corresponding portion of the chart.

In one embodiment, the system and method to generate charts may be implemented utilizing an HTML-Business for Java (HTMLB) control, such as a chart control. The chart control, in one embodiment, may include a plurality of properties, such as a chart type property, data source property, scaling property, axis title properties, and a legend position property. The type chart property determines the type of graphics, such as a pie chart, a bar graph, an area graph, as well as other types of graphics. The chart control is “data driven”, i.e. it relies heavily on the concept of data binding. Thus, the data source property is assigned to a suitable external table. A suitable table, in one embodiment, includes at least the following:

The name of the data series (wherein each data series corresponds to an associated data set);

A column containing the x-values (X) (e.g., categories);

A column containing the y-values (Y);

A column containing optional z-values (Z);

An optional color; and

An optional extension.

The chart control may be utilized to display multiple data sets at the same time to allow, for example, comparison of operation costs associated with materials with operational costs associated with labor, as illustrated in FIG. 1A. In one embodiment, the chart control may display categories in different colors taken from a number of predefined color schemes. Any table containing the above-mentioned columns is accepted, in one embodiment, as data source, even if the table also includes other columns as well. The scaling property determines the scaling of the y-axis. Furthermore, the chart control may provide a title, a legend, as well as labels for x-axis and y-axis. The axis title properties determine a title for categories (x-axis) and a title for values (y-axis). In the example illustrated in FIG. 1A, the title for categories may “Months” (not shown), and the title for values is “Amount in USD” (not shown). A legend, such as the legend in FIG. 1A, may be created automatically from names and colors of the corresponding data series. The position of the legend with respect to the graph may be set explicitly with the legend position property.

The chart control may be based on a Java applet. Thus, the usual style sheet customizing used by other HTMLB components may not be applicable to the chart control. In order to allow customization, the chart control may simulate at least a subset of cascading style sheets (CSS) attributes, such as color and font attributes.

The chart control may be utilized to generate a chart model that may include one or more items having one or more associated tool tips, or one or more links to respective relevant charts providing further details about the item.

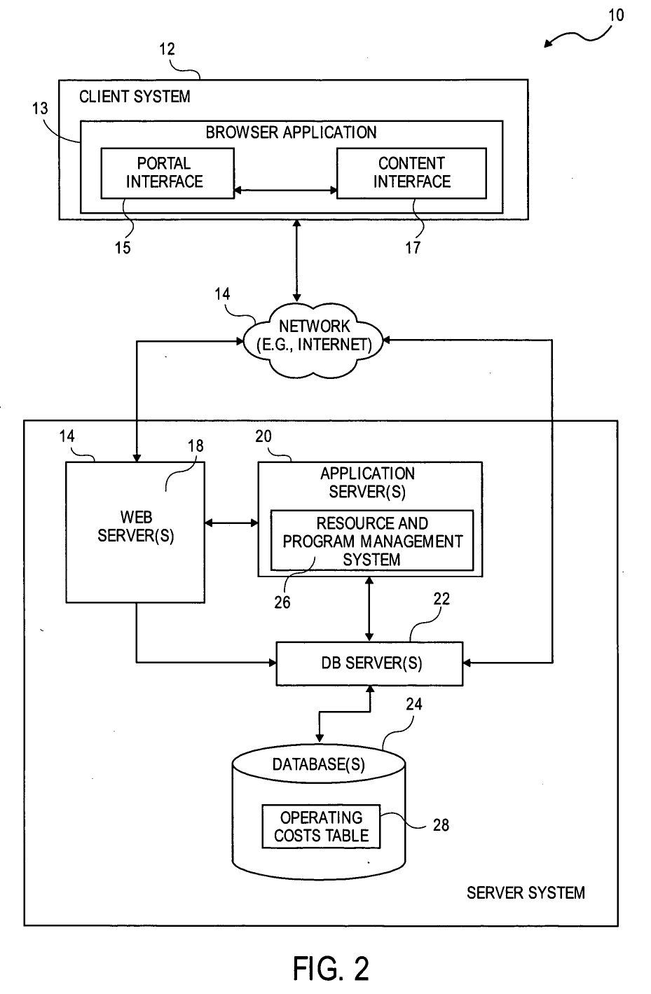

The system to drill down graphically may be implemented within a system 10 having client-server architecture, as illustrated in FIG. 2. The system 10 includes a client system 12 coupled via a network 14 (e.g., the Internet or an intranet) to a server system 16, so as to facilitate communications (e.g., utilizing any one of a number of well-known network communication protocols, such as HTTP) between the client system 12 and the server system 16. The client 12 may be any computing device, including a laptop computer, notebook computer, personal digital assistant (PDA), or handheld wireless phone. The client system 12 may further host a number of client applications, such as a browser application (e.g., MS EXPLORER®, developed by Microsoft Corporation of Redmond, of Washington State). The browser application may include a portal interface and a content interface.

The server system 16, in one exemplary embodiment, may include a web server 18, an application server 20, and a database (DB) server 22. The database server 22 may be connected a database 24. The application server 20 may be deployed to support one or more applications, and may utilize the database server 22 to store and to retrieve data from a database 24. In one embodiment, the application server 20 hosts an application (e.g., a resource and program management system 26), which may be utilized, for example, to enable a user to view graphical representation of business data as a chart (e.g., as a table, as a bar graph, or as a pie chart). The database 24 may, for example, store data such as project information in an exemplary form of operating costs table, and other information. The data within the database 24 may be stored in any one of a number of forms, such as, for example, flat files, relational tables objects, or as XML (eXtensible Markup Language) data structures. The application servers 20 may also be coupled to one or more web servers 18, so as to facilitate the delivery of web content, including content containing embedded code, such as Java, to the portal interface 15 and the content interface 17.

In one exemplary embodiment, the portal interface 15 may facilitate user access to one or more applications hosted on the application server 20, such as a resource and program management system 26. The portal interface 15 is shown to invoke the content interface 17 within which content associated with a web-based application may be presented to a user. Specifically, the content interface 17 may communicate with the one or more applications hosted on the application server 20, at least one of which may be responsible for the delivery of content to the content interface 17. Both the portal interface 15 and the content interface 17 may communicate with the server system 16 via the network 14.

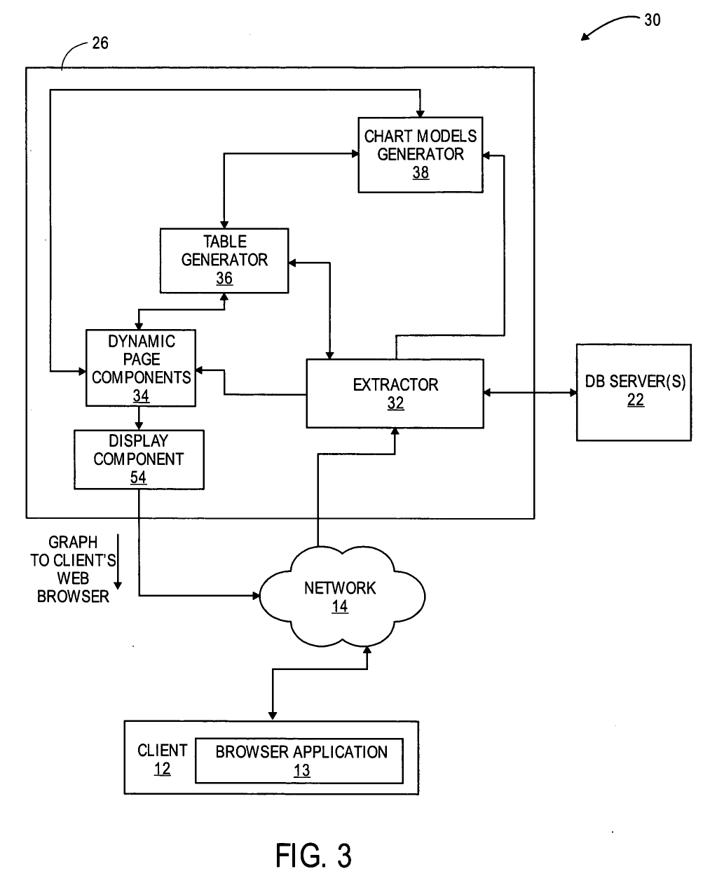

FIG. 3 is a block diagram illustrating a business platform, in the exemplary form of the network-based resource and program management system 26, according to one embodiment of the present invention. In one embodiment, the resource and program management system 26 provides server-side functionality, via the network 14 (e.g., the Internet), to the one or more clients 12 and may be configured to provide a number of business management functions and services to users.

Specifically, the system 26 may allow the client 12 to request and receive a graphical representation of business data and to drill down graphically. The resource and project management system 26 may include an extractor 32, dynamic page components 34, a table generator 36, a chart models generator 38, and a display component 54. The extractor 32 may be configured to receive a client's request for a chart in accordance with the client's business data and to receive chart data associated with the requested chart (e.g., via the web server 18 making a back end call in order to retrieve appropriate chart data). The client's business data (including the chart data) may be stored in the database 24. The extractor 32 provides the chart data to the dynamic page component, which, in turn, provides this data to the chart models generator 38. In one exemplary embodiment, the extractor 32 may provide chart data directly to the to the chart models generator 38. The dynamic page component 34 may generate dynamic web pages utilizing the chart models generated by the chart models generator 38, and provide them to the display component 54.

The chart data received by the extractor 32 may include, in one exemplary embodiment, an indication that one or more items in the chart data is associated with other charts that may provide additional details regarding such items. An item having an associated link to another chart may be referred to as an expandable item. If the system 26 determines that the chart data includes an expandable item, the chart models generator generates a chart model corresponding to the chart referred to by the expandable item. The determination of the chart data having expandable items may be made, in one embodiment, by the dynamic page component 34. In such a case, the dynamic page component 34 sends an indication to the chart models generator 38 to generate chart models associated with charts referred to by the extendable items. In another exemplary embodiment, the determination of the chart data having expandable items may be made by the chart models generator 38. Similarly, the dynamic page component 34 generates the charts identified by the links in the expandable items and the respective URLs.

With reference to FIGS. 1A-1C, when the extractor 32 receives a request from a user for a chart of FIG. 1A, the chart models generator 38 generates the chart model for the graph of FIG. 1A as well as for the charts associated with any expandable items of the chart model for the graph of FIG. 1A. It will be noted, that, in this example, if no portion of the graph in FIG. 1A is linked (e.g., via a URL) to the graph of FIG. 1C, then the chart model, URL, and the chart itself are not generated for the graph of FIG. 1C until a user selects a certain expandable item of FIG. 1A. Thus, if the graph represented in FIGS. 1A, 1B, and 1C are referred to as an initial chart, a first level details chart, and a second level details chart respectively, then the chart model, the chart and the associated URL for the second level details chart need not be generated until the system 26 receives a request for the first level chart. Thus, in one exemplary embodiment, charts and models are generated on demand, e.g., only for the current level and only one level below, which may improve performance of the system 26.

According to one exemplary embodiment, an expandable item in a chart model may have several links to several different details charts. For example, the labor costs stack in FIG. 1A may have associated links to a personnel compensation chart and, for example, bonuses distribution chart. The dynamic page component 34 may generate a hover menu to be presented to a user as the user places the cursor over an expandable item, so that the user may select the associated chart or group of charts, which is of interest to the user.

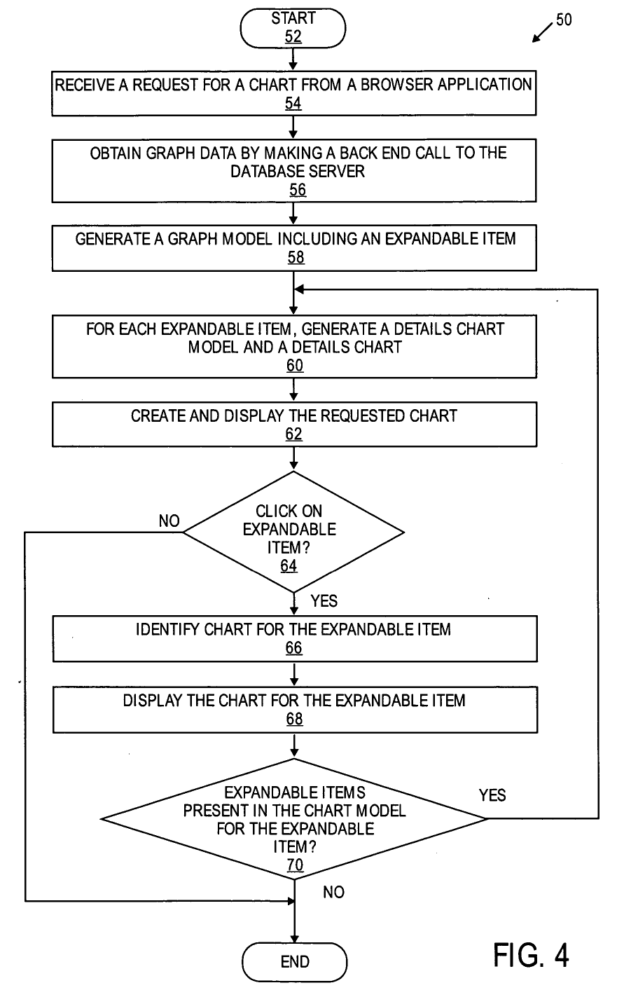

FIG. 4 is a flow chart illustrating a method 50 to drill down graphically, according to one embodiment of the present invention. The method 50 commences at operation 52. At operation 54, an application, such as the resource and program management system 26, receives a request from a user (e.g., the browser application 13) for an initial chart (e.g., the costs bar graph of FIG. 1A). Responsive to the receiving of the request, the system 26 obtains data necessary to generate the requested chart. The data may be obtained, at operation 56, by means of the web server 18 making a back end call to the database server 22. The chart data is utilized by the system 26 to generate an initial chart model at operation 58 (e.g., a chart model corresponding to the costs chart of FIG. 1A). With reference to FIGS. 1A-1C, the initial chart model corresponding to the costs graph of FIG. 1A has an expandable item corresponding to the graphical representation of the labor costs for the month of October. As described with reference to FIG. 3, the chart models generator 38 generates, at operation 60, a first level details chart model for each expandable item identified in the chart data for the initial chart requested at operation 54. The dynamic page component 34, in turn, generates the charts corresponding to the first level detailed chart models (e.g., corresponding to the labor costs chart of FIG. 1B) and one or more URLs corresponding to the links identified in the expandable items of the initial chart model. At operation 62, the initial chart (e.g., the chart of FIG. 1A) is generated and provided to the browser application thereby enabling the browser application 13 to render the requested chart.

At operation 64, if the system 26 determines that a request for a chart associated with an expandable item has been received (e.g., when a user clicks on the labor costs stack in FIG. 1A), the system 26 identifies the chart associated with the expandable item at operation 66 (e.g., the labor costs graph of FIG. 1B) and provides the chart, which can be referred to as the first level details chart, to the user at operation 68. If it is determined, at operation 70, that the first level details chart, associated with the expandable item (e.g., the labor costs graph of FIG. 1B), itself has one or more expandable items (e.g., the development stack in the graph of FIG. 1B), then the method 50 proceeds to operation 60, where the chart models generator 38 generates second level details chart models for each expandable item identified in the first level details chart. The operations 60 through 70 may be repeated until the user is satisfied with the level of detail or until the next presented chart does not have any expandable items.

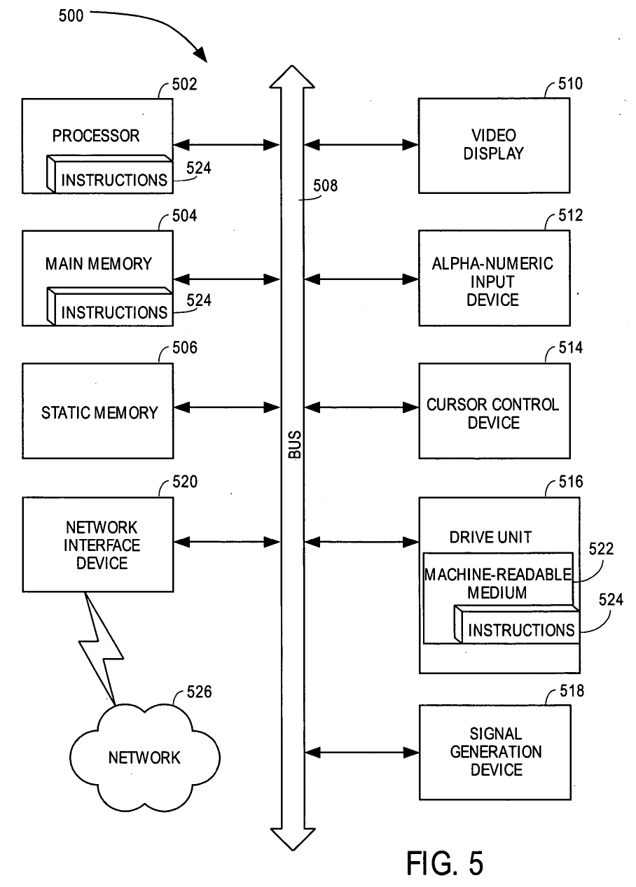

FIG. 5 illustrates a diagrammatic representation of machine in the exemplary form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processor 502 (e.g., a central processing unit (CPU) a graphics processing unit (GPU) or both), a main memory 504 and a static memory 506, which communicate with each other via a bus 508. The computer system 300 may further include a video display unit 510 (e.g., a liquid crystal display (LCD) or a cathode ray tube (CRT)). The computer system 300 also includes an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions (e.g., software 524) embodying any one or more of the methodologies or functions described herein. The software 524 may also reside, completely or at least partially, within the main memory 504 and/or within the processor 502 during execution thereof by the computer system 300, the main memory 504 and the processor 502 also constituting machine-readable media. The software 524 may further be transmitted or received over a network 526 via the network interface device 520.

While the machine-readable medium 522 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to drill down graphically have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A system to drill down graphically, the system including:
a chart models generator to generate an initial chart model and a first level details chart model, wherein the initial chart model includes a first expandable item including a link to a first level details chart associated with the first level details chart model;
a dynamic page component to generate an initial chart corresponding to the initial chart model and the first level details chart corresponding to the details chart model, wherein the initial chart includes a graphical representation of the first expandable item; and
a display component to provide the details chart to a user, responsive to a selection of the graphical representation of the first expandable item by the user.

2. The system of claim 1, wherein the first level details chart model includes a second expandable item, the second expandable item including a link to a second level details chart, the second level details chart being to provide additional information associated with the second expandable item.

3. The system of claim 2, wherein the chart models generator is to generate a second level details chart model corresponding to the second level details chart responsive to the selection of the graphical representation of the first expandable item by the user.

4. The system of claim 2, wherein the dynamic page component is to generate the second level details chart responsive to the selection of the graphical representation of the first expandable item by the user.

5. The system of claim 2, wherein the display component is to provide the first level details chart to the user responsive to the selection of the graphical representation of the first expandable item by the user.

6. The system of claim 1, wherein the dynamic page component is to generate a URL corresponding to the link to the first level details chart.

7. The system of claim 1, wherein the first expandable item includes a tool tip.

8. The system of claim 1, wherein the first expandable item is from a plurality of expandable items associated with the initial chart.

9. The system of claim 1, wherein the link to the first level details chart is from a plurality of links to respective details charts, wherein all links from the plurality of links are associated with the first expandable item.

10. The system of claim 1, wherein the dynamic page component is to generate a hover menu including a plurality of URLs corresponding to the plurality of links associated with the first expandable item, the hover menu to be presented to the user responsive to placing a cursor over the first expandable item by the user.

11. A method to drill down graphically, the method including:
generating an initial chart model, including generating a first expandable item associated with the initial chart model, wherein the first expandable item includes a link to a first level details chart;
generating an initial chart corresponding to the initial chart model, the initial chart including a graphical representation of the first expandable item;
generating a first level details chart model;
generating the first level details chart associated with the first level details chart model; and
providing the first level details chart to a user, responsive to a selection of the graphical representation of the first expandable item by the user.

12. The method of claim 11, wherein the generating of the first level details chart model includes generating a second expandable item, the second expandable item including a link to a second level details chart, the second level details chart being to provide additional information associated with the second expandable item.

13. The method of claim 12, including generating a second level details chart model corresponding to the second level details chart responsive to the selection of the graphical representation of the first expandable item by the user.

14. The method of claim 12, including generating the second level details chart responsive to the selection of the graphical representation of the first expandable item by the user.

15. The method of claim 12, including providing the second level details chart to the user responsive to a selection of a graphical representation of the first expandable item by the user.

16. The method of claim 11, including generating a URL corresponding to the link to the first level details chart.

17. The method of claim 11, wherein the first expandable item is from a plurality of expandable items associated with the initial chart.

18. The method of claim 11, wherein the link to the first level details chart is from a plurality of links to respective details charts, wherein all links from the plurality of links are associated with the first expandable item.

19. The method of claim 18, including:
generating a hover menu including a plurality of URLs corresponding to the plurality of links associated with the first expandable item; and
presenting the hover menu to the user responsive to placing a cursor over the first expandable item by the user.

20. A method to drill down graphically, the method including:
means for generating an initial chart model, including generating a first expandable item associated with the initial chart model, wherein the first expandable item includes a link to a first level details chart;
means for generating an initial chart corresponding to the initial chart model, the initial chart including a graphical representation of the first expandable item;
means for generating a first level details chart model;
means for generating the first level details chart associated with the first level details chart model; and
means for providing the first level details chart to a user, responsive to a selection of the graphical representation of the first expandable item by the user.

21. A machine-readable medium having stored thereon data representing sets of instructions which, when executed by a machine, cause the machine to:
generate an initial chart model and a first level details chart model, wherein the initial chart model includes a first expandable item including a link to a first level details chart associated with the first level details chart model;
generate an initial chart corresponding to the initial chart model and the first level details chart corresponding to the details chart model, wherein the initial chart includes a graphical representation of the first expandable item; and
provide the details chart to a user, responsive to a selection of the graphical representation of the first expandable item by the user.
